(19) United States
(12) Patent Application Publication
(10) Pub. No.: US 2024/0312217 A1
(43) Pub. Date: Sep. 19, 2024

(54) OBJECT TRACKING SYSTEM FOR USE IN TRAFFIC FLOW ANALYTICS AND A TRAFFIC FLOW ANALYTIC METHOD

(71) Applicant: Logistics and Supply Chain MultiTech R&D Centre Limited, Hong Kong (HK)

(72) Inventors: Chun Hung CHENG, Hong Kong (HK); Kwong Tim CHAN, Hong Kong (HK); Cheuk Wai KUNG, Hong Kong (HK)

(21) Appl. No.: 18/185,016

(22) Filed: Mar. 16, 2023

(51) Int. Cl. G06V 20/54; B64U 10/00; G06T 7/246; G06V 20/17; G08G 1/01; G08G 1/017

(52) U.S. Cl. CPC G06V 20/54; B64U 10/00; G06T 7/248; G06V 20/17; G08G 1/012; G08G 1/0125; G08G 1/0175; B64U 2101/30; G06T 2207/10016; G06T 2207/10032; G06T 2207/20092; G06T 2207/30236; G06T 2207/30241; G06V 2201/08

(57) ABSTRACT

An object tracking system for use in traffic flow analytics and a traffic flow analytic method. The system comprises: an image processing module arranged to receiving a sequence of images capturing at least one object moving along a predetermined path in an area; an object detection module arranged to detect the at least one object including identifying a predetermined category of the detected object; and an object tracking module arranged to track the at least one object travelling from an entrance to an exit of the predetermined path based on coordinates of the object in the sequence of images being detected.

### TECHNICAL FIELD

The invention relates to an object tracking system for use in traffic flow analytics and a traffic flow analytic method, and particularly, although not exclusively, to an object tracking system employing artificial intelligence and computer vision technologies.

### BACKGROUND

Traffic flow analytics is the process of analyzing the movement of vehicles, pedestrians, and other road users to improve traffic efficiency and safety, and the analysis may provide valuable insights into traffic patterns and volumes.

For example, manual traffic counting may be employed to obtain data for traffic flow analysis, the method may involves observing and recording the number and types of vehicles that pass through a specific point on a road over a specified period. This approach is labor-intensive and may not be accurate, and the manual approach may also have other limitations regarding cost and scalability.

### SUMMARY OF THE INVENTION

In accordance with a first aspect of the present invention, there is provided an object tracking system for use in traffic flow analytics, comprising: an image processing module arranged to receiving a sequence of images capturing at least one object moving along a predetermined path in an area; an object detection module arranged to detect the at least one object including identifying a predetermined category of the detected object; and an object tracking module arranged to track the at least one object travelling from an entrance to an exit of the predetermined path based on coordinates of the object in the sequence of images being detected.

In accordance with the first aspect, the sequence of images are captured by an unmanned aircraft system.

In accordance with the first aspect, the sequence of images are captured at a shooting angle of a top view or a tilt view.

In accordance with the first aspect, the object detection module comprises a modified tiny object detection network arranged to process the sequence of images.

In accordance with the first aspect, the modified tiny object detection network is arranged to process a plurality of at least partially overlapping image tiles having an image resolution smaller than an original resolution of the sequence of images.

In accordance with the first aspect, the object tracking module is arranged to assign a track ID for each of the at least one object being detected; and to track the movement of the at least one object using a Simple Online and Realtime Tracking with a Deep Association Metric process.

In accordance with the first aspect, the object tracking module is further arranged to assign a new track ID to a lost object which is not detectable in one or more previous frames; and to perform a merge track process to determine whether an identical object assigned with different track IDs travelled from the entrance to the exit of the predetermined path.

In accordance with the first aspect, the system further comprises a correction module arranged to correct a trajectory of the at least one object with reference to a template image representing a stabilizing region in the sequence of images.

In accordance with the first aspect, the correction module is arranged to slide the template image defined by a user selected from one of the images in the sequence of image to match with an identical region in each of the images in the sequence; and to correcting the coordinate of the detected object by offsetting the movement of the unmanned aircraft system based on a shift of the template image at different frames of the sequence of image.

In accordance with the first aspect, the predetermined category of the detected object includes at least one of pedestrians, a taxi, a coach, a bus, a tram, a collection truck and a special purpose vehicle.

In accordance with a second aspect of the present invention, there is provided a traffic flow analytic method, comprising the steps of: receiving a sequence of images capturing at least one object moving along a predetermined path in an area; detecting the at least one object including identifying a predetermined category of the detected object; and tracking the at least one object travelling from an entrance to an exit of the predetermined path by detecting coordinates of the object in the sequence of images.

In accordance with the second aspect, the sequence of images are captured by an unmanned aircraft system.

In accordance with the second aspect, the sequence of images are captured at a shooting angle of a top view or a tilt view.

In accordance with the second aspect, the step of detecting the at least one object comprising the step of processing the sequence of images by using a modified tiny object detection network.

In accordance with the second aspect, the modified tiny object detection network is arranged to process a plurality of at least partially overlapping image tiles having an image resolution smaller than an original resolution of the sequence of images.

In accordance with the second aspect, the step of tracking the at least one object travelling from the entrance to the exit of the predetermined path comprises the step of: assigning a track ID for each of the at least one object being detected; and using a Simple Online and Realtime Tracking with a Deep Association Metric process to track the movement of the at least one object.

In accordance with the second aspect, the step of tracking the at least one object travelling from the entrance to the exit of the predetermined path further comprises the steps of: assigning a new track ID to a lost object which is not detectable in one or more previous frames; and performing a merge track process to determine whether an identical object assigned with different track IDs travelled from the entrance to the exit of the predetermined path.

In accordance with the second aspect, the method further comprises the step of correcting a trajectory of the at least one object with reference to a template image representing a stabilizing region in the sequence of images.

In accordance with the second aspect, the step of correcting the trajectory of the at least one object comprising the steps of: sliding the template image defined by a user selected from one of the images in the sequence of image to match with an identical region in each of the images in the sequence; and correcting coordinates of the detected object by offsetting the movement of the unmanned aircraft system based on a shift of the template image at different frames of the sequence of image.

In accordance with the second aspect, the predetermined category of the detected object includes at least one of pedestrians, a taxi, a coach, a bus, a tram, a collection truck and a special purpose vehicle.

### BRIEF DESCRIPTION OF THE DRAWINGS

Embodiments of the present invention will now be described, by way of example, with reference to the accompanying drawings in which:

FIG. 1 is a block diagram of an object tracking system in accordance with an embodiment of the present invention.

FIG. 2 is an image in an input image sequence showing a plurality of objects travelling with different path in the area captured in the image sequence in accordance with an embodiment of the present invention.

FIG. 3 is a traffic flow diagram showing the paths of the plurality of objects being identified in the image of FIG. 2.

FIG. 4 is a collection of six image sections of the image of FIG. 2 each being created for object tracking analysis by the system of FIG. 1.

FIG. 5 is a zoomed-in image showing a portion of FIG. 2 and the identified object being label with different track IDs.

FIG. 6A is an image showing a plurality of objects travelling around a roundabout.

FIG. 6B is an image showing a plurality of objects travelling around a roundabout at a time different from when FIG. 6A is captured.

FIG. 6C is an illustration showing a merge process which identifies a same vehicle with different track IDs as presented on FIGS. 6A and 6B.

FIG. 7 is a traffic flow diagram showing the traffic analysis of the roundabout area in FIGS. 6A to 6C.

FIG. 8 is a heatmap showing an example traffic analysis performed by the system of FIG. 1.

FIG. 9 is an image showing a tilt view of an area.

FIG. 10 is an image showing a top view of an area.

FIG. 11 is an image a sliding window being defined by an operator for use in a correction process performed by the system of FIG. 1.

FIG. 12 is an illustration of a job allocation process perform by the system of FIG. 1.

FIG. 13 is a flow diagram of the job allocation process of FIG. 12.

### DETAILED DESCRIPTION OF THE PREFERRED EMBODIMENTS

The inventors devised that, Traffic management and surveillance have always been challenging tasks. Newer approaches of traffic analytic may help providing more advanced traffic flow analytics capabilities.

Traffic monitoring is a crucial aspect of traffic management and surveillance, and it involves the observation and analysis of the movement of vehicles, pedestrians, and other modes of transportation in a particular area. This process typically involves the use of cameras or sensors to collect data on traffic flow, vehicle classification, pedestrian count, and vehicle tracking.

Traffic monitoring can provide valuable information that can be used to improve traffic flow, plan infrastructure changes, and enhance public safety. For instance, traffic monitoring can help identify areas with high traffic congestion, which can inform the design of new roads or the expansion of existing ones. It can also help identify areas with high accident rates, which can inform the implementation of new safety measures.

For example, video-based traffic analysis may be used, which involves using cameras to capture traffic movements and then analyzing the footage to extract information on traffic volumes, speeds, and patterns. This approach can provide more accurate and detailed data than manual counting and can also be used for real-time monitoring and control.

In an alternative example, inductive loop detectors may be employed. These detectors may be sensors embedded in the road surface that detect vehicles passing over them. They can be used to measure traffic volumes, speeds, and occupancy and can provide real-time data for traffic management and control.

Alternatively, bluetooth tracking may be employed, which involves detecting the unique Bluetooth signals emitted by mobile devices in passing vehicles. This approach can provide detailed information on travel times, speeds, and routes, but it requires a high degree of accuracy in detecting and tracking Bluetooth signals.

In recent years, the development of unmanned aircraft systems (UAS), also known as drones, has revolutionized the field of traffic monitoring. UAS equipped with artificial intelligence (AI) tools can provide a more detailed and comprehensive analysis of traffic conditions, including the classification of different types of vehicles, pedestrian flow, and average time crossing the junction. UAS can also operate in hazardous environments, such as areas affected by natural disasters or industrial accidents, without risking the lives of pilots.

Advantageously, UAS with AI technology has revolutionized the way traffic surveys are conducted, providing a more detailed and comprehensive analysis of traffic flow, vehicle classification, pedestrian count, and vehicle tracking.

Without wishing to be bound by theory, unmanned Aircraft Systems (UAS), also known as drones, are aircraft that operate without a human pilot onboard. UAS can be remotely controlled or can operate autonomously using pre-programmed flight plans. These systems are equipped with advanced technologies and sensors that enable them to collect and transmit data from various environments. They can be used for a wide range of applications, including but not limited to, surveillance, search and rescue, scientific research, and mapping.

UAS may be designed to be more cost-effective and safer than traditional manned aircraft. They are smaller and lighter, making them easier to transport and maneuver in tight spaces. Unlike manned aircraft, UAS can operate in hazardous environments, such as areas affected by natural disasters or industrial accidents, without risking the lives of pilots.

In addition, UAS may capture high-resolution images and video from above. This feature is particularly useful in traffic management and surveillance, as UAS can be used to monitor traffic flow, vehicle classification, pedestrian count, and vehicle tracking. In addition, the incorporation of AI computer vision technology in traffic management, a more detailed and comprehensive analysis of traffic conditions may be provided.

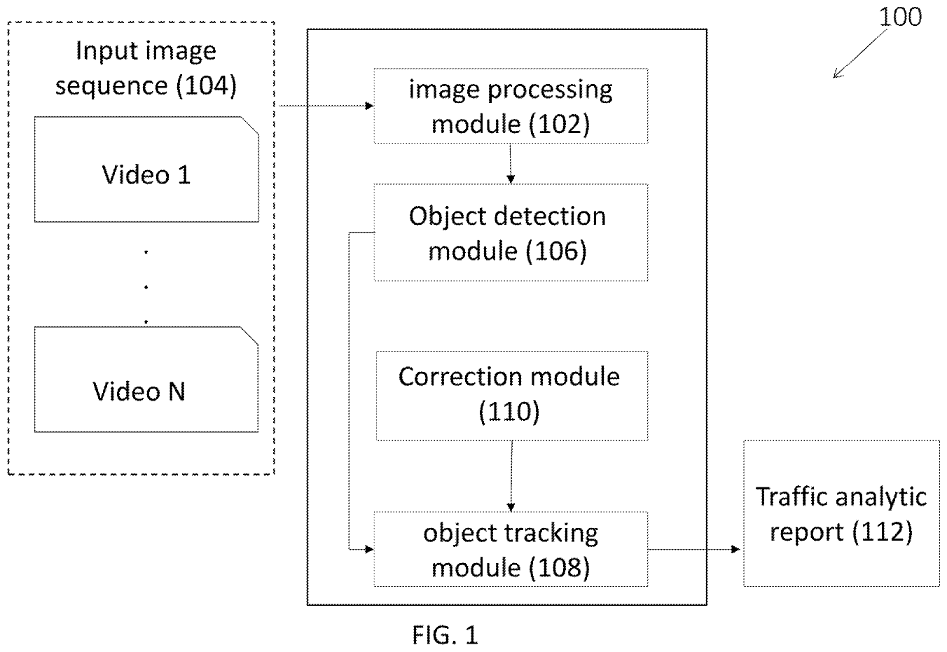

With reference to FIG. 1, there is shown an embodiment of the an object tracking system 100 for use in traffic flow analytics, comprising: an image processing module 102 arranged to receiving a sequence of images 102 capturing at least one object moving along a predetermined path in an area; an object detection module 106 arranged to detect the at least one object including identifying a predetermined category of the detected object; and an object tracking module 108 arranged to track the at least one object travelling from an entrance to an exit of the predetermined path based on coordinates of the object in the sequence of images being detected.

In this example, video clip consisting of a sequence of images may be captured a predetermined elevation, such as by capturing the images using an unmanned aircraft system or a drone, and the video clip may be further provided to the object tracking system 100 for identifying the travelling paths of all objects in concern. By identifying all travelling paths of the tracked object during predetermined period of time, traffic flow in the captured area may be analyzed.

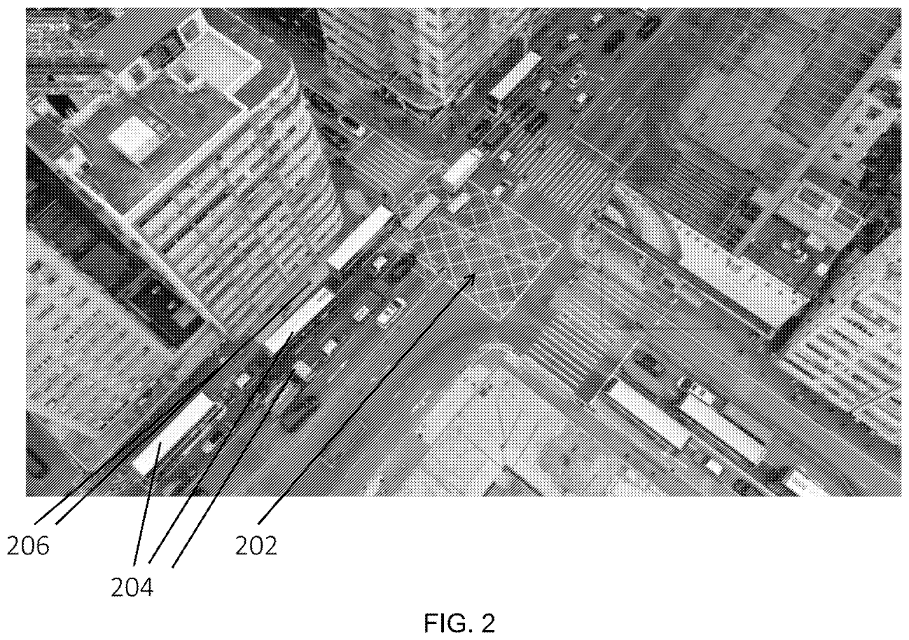

For example, referring also to FIG. 2, a video clip of a road junction 202 may be captured by a drone system (non-shown), in which a plurality of vehicles 204 as well as pedestrians 206 travelled on the road in different paths in the video clip during a certain period of time. The objection detection module 106 may detect all these track objects of different types/categories, and the objection tracking module 108 may track the travelling path of each of these objects to identify how the track object moves, e.g. from an entrance to an exit defined on the image. In one example embodiment, a traffic flow analytic report 112 associated with the traffic conditions of the captured are may be output which may help traffic planning or control by administrations, such as a transportation department.

The image processing module 102 may be used for performing any necessary image pre-processing such as tuning the brightness and contrast of the input video clip if necessary.

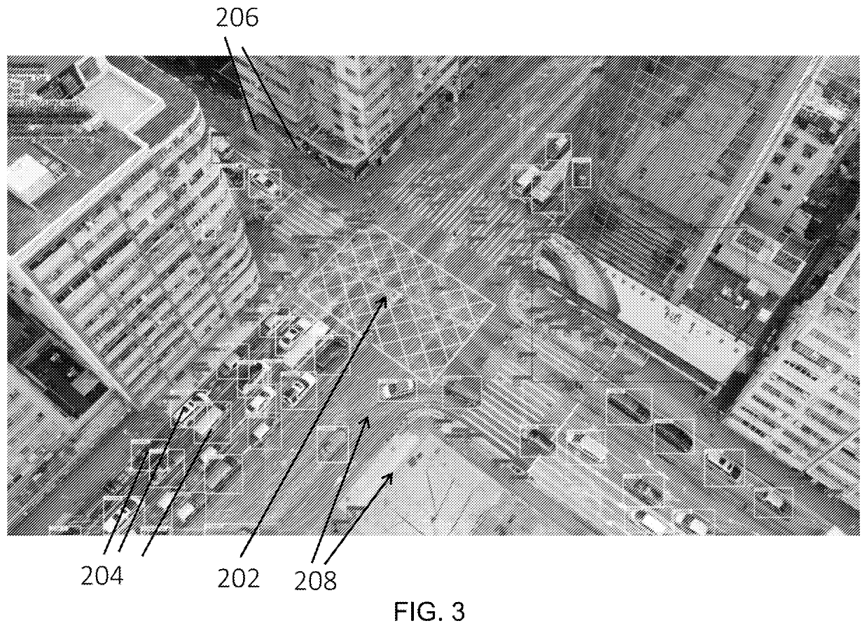

Preferably, the object tracking module 108 is arranged to assign a track ID for each of the at least one object 204/206 being detected. With reference to FIG. 3, each of the detected object 240/206 in the captured image is assigned with a unique ID, and subsequently the travelling path 208 of the tracked object 204/206 is recorded, by analyzing the position of the coordinates of the tracked object. Advantageously, by assigning a unique track ID to each of the objects, the number of the different tracked objects to be counted is more accurate.

Preferably, the predetermined category of the detected object includes at least one of pedestrians, a taxi, a coach, a bus, a tram, a collection truck and a special purpose vehicle. In one preferred embodiment, the system may classify more than twelve categories of vehicles that use a particular road, including motorcycles, private cars, taxis, buses, coaches, vans, minibuses, trucks, police cars, fire trucks, ambulances, correctional vehicles, medium goods vehicle, heavy goods vehicle, tram, collection truck, special purpose vehicle, and light rail transit. This feature may be useful for identifying any potential safety hazards and for traffic management authorities to make informed decisions. In addition, it may be useful for identifying the different types of vehicles and pedestrians that pass through different regions and intersections, and for analyzing traffic flow and congestion based on these categories.

Alternatively or optionally, the system may be used for tracking or detecting other types of vehicles or objects, as appreciated by a skilled person in the field.

The functional units and modules of the object tracking system in accordance with the embodiments disclosed herein may be implemented using computing devices, computer processors, or electronic circuitries including but not limited to application specific integrated circuits (ASIC), field programmable gate arrays (FPGA), microcontrollers, and other programmable logic devices configured or programmed according to the teachings of the present disclosure. Computer instructions or software codes running in the computing devices, computer processors, or programmable logic devices can readily be prepared by practitioners skilled in the software or electronic art based on the teachings of the present disclosure.

All or portions of the methods in accordance to the embodiments may be executed in one or more computing devices including server computers, personal computers, laptop computers, mobile computing devices such as smartphones and tablet computers.

The embodiments may include computer storage media, transient and non-transient memory devices having computer instructions or software codes stored therein, which can be used to program or configure the computing devices, computer processors, or electronic circuitries to perform any of the processes of the present invention. The storage media, transient and non-transient memory devices can include, but are not limited to, floppy disks, optical discs, Blu-ray Disc, DVD, CD-ROMs, and magneto-optical disks, ROMs, RAMs, flash memory devices, or any type of media or devices suitable for storing instructions, codes, and/or data.

Each of the functional units and modules in accordance with various embodiments also may be implemented in distributed computing environments and/or Cloud computing environments, wherein the whole or portions of machine instructions are executed in distributed fashion by one or more processing devices interconnected by a communication network, such as an intranet, Wide Area Network (WAN), Local Area Network (LAN), the Internet, and other forms of data transmission medium.

Preferably, the object detection module 106 comprises a modified tiny object detection network arranged to process the sequence of images 104, more preferably, the modified tiny object detection network is arranged to process a plurality of at least partially overlapping image tiles having an image resolution smaller than an original resolution of the sequence of images.

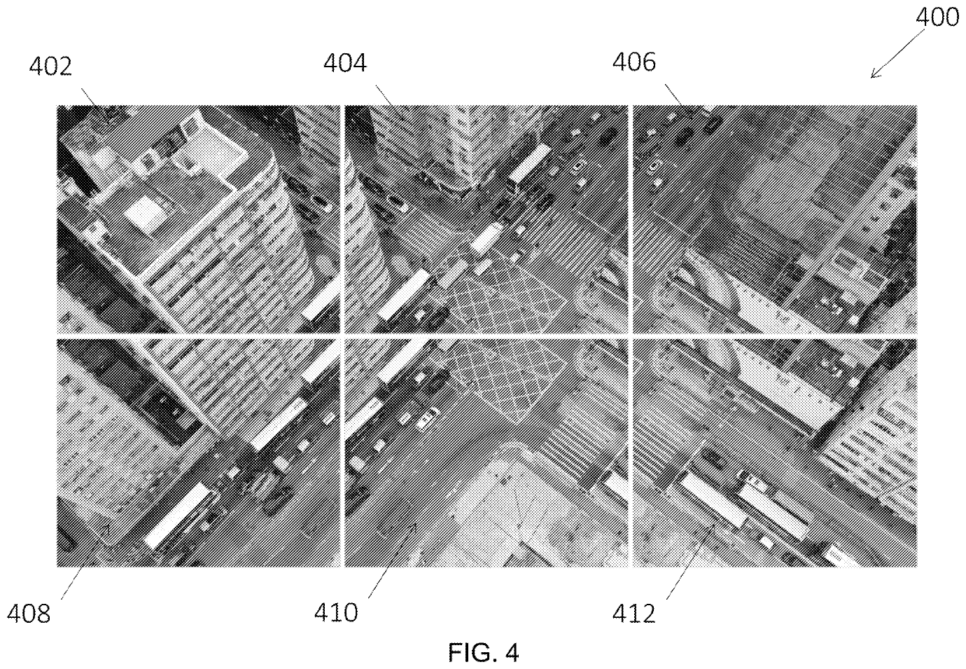

For example, with reference to FIGS. 4, the drone system supports tiny object detection using a YOLOv3 Tiny AI Detection Model. This model may be used for faster execution, with standard input resolution of 416×416 pixels. Alternatively, the accuracy of object detection and classification of vehicle type may be improved by modifying the network to YOLOv3 Tiny with 608×608 input size, or in some alternative examples, and input image tile with a higher resolution.

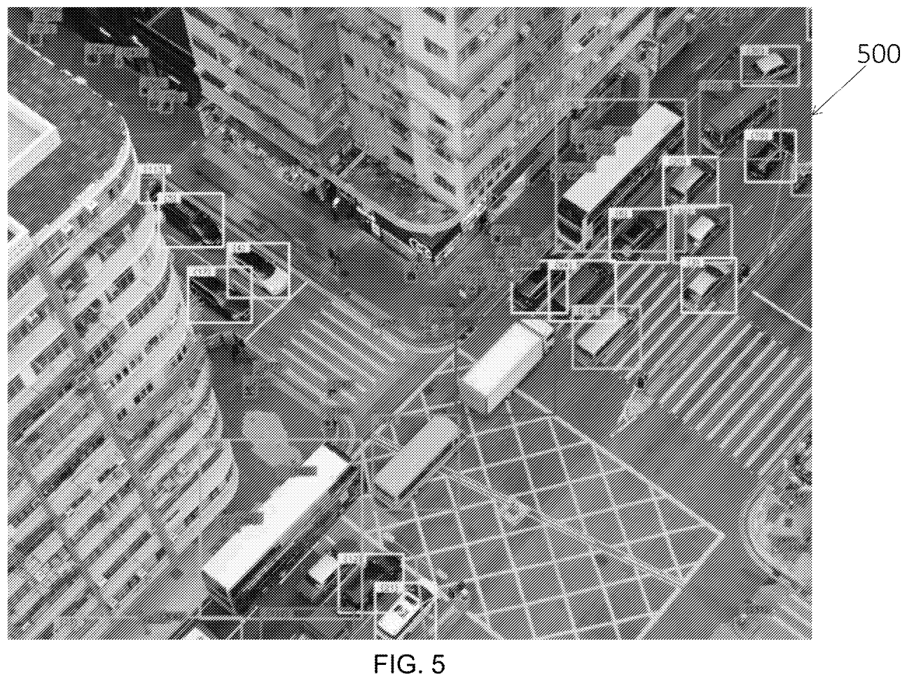

Referring to FIG. 5 an original 4K image 500 may be downsample to an input size of 416x416 or 608x608 as described earlier. The smallest detectable size may be 32x32 pixels, or other block size in other applications, e.g. in case a higher accuracy of category detection is required. This feature is particularly useful for detecting smaller vehicles, such as motorcycles or bicycles, which may be missed by regular ground-based monitoring or larger drones.

In addition, the original image 400 may be tiled into 3×2 small tiles 402, 404, 406, 408, 410 and 412 (e.g. each 1536x1234 pixels), and preferably, adjacent tiles overlap with each other to preserve object detection along the boundaries. Upon completing detection of objects in every small image, the results may be merged for final detection results in original 4K resolution.

Preferably, to achieve multiple object tracking, the object tracking module 108 is further arranged to track the movement of the at least one object using a Simple Online and Realtime Tracking with a Deep Association Metric process (Deep SORT). This method tracks objects by detection, using CNN to extract features of the object, Kalman Filter to predict future positions based on current position, Hungarian algorithm to associate an object in current frame with the one in previous frame, IOU of detection and tracking, and cosine similarity to compare features of the visual appearance. Each object will then have their own track ID.

The multiple object tracking feature can provide a more accurate count of the traffic flow, while the roundabout traffic flow analysis can help determine how efficient the roundabout design is. The system can also provide counts for the entry and exit lanes, as well as flow rates from origin to destination. The accuracy of the multiple object tracking feature is especially important when it comes to origin-destination counts.

Additionally, a merge track process can be used to reduce duplicate counts, making the system even more reliable for traffic analysis. In one example embodiment, the merge track process may be performed based on a distance of two tracks and within a short time difference between last seen of old track and first seen of new track is particularly useful for analyzing traffic flow in complex urban environments, where multiple vehicles may pass through the same region at different times.

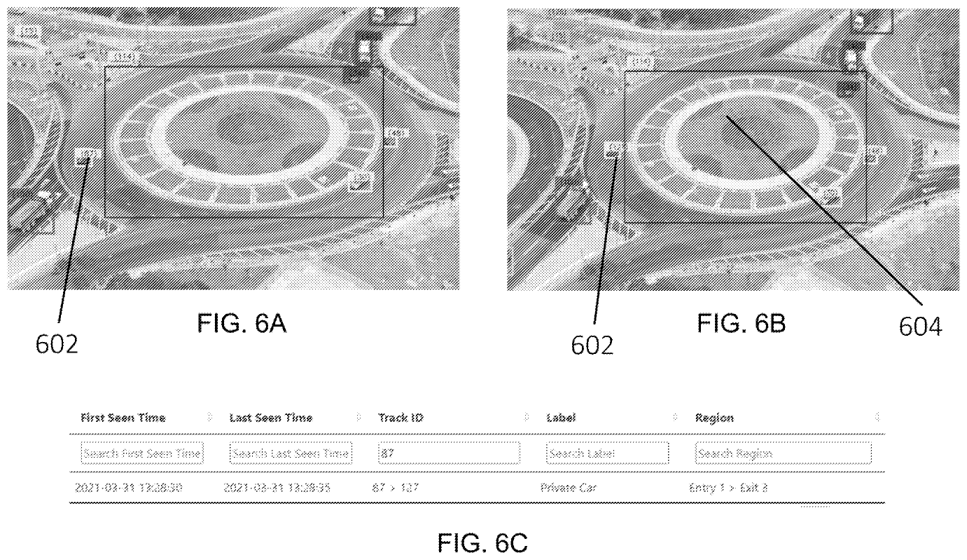

For example, with reference to FIG. 6A to 6C, the object tracking module 108 may assign a new track ID to a lost object which is not detectable in one or more previous frames; and to perform a merge track process to determine whether an identical object assigned with different track IDs travelled from the entrance to the exit of the predetermined path. In this example, the same tracked object 602 assigned with a first ID 87, and then later a second ID or a new track ID 127, may be identified as an identical object travelling around the roundabout 604, and thus the system identifies that the same object 602 travel from “Entry 1” to “Exit 3” rather than identifying two vehicles travelling around the roundabout.

Advantageously, duplicate counts are reduced by using a merge track algorithm based on the distance of two tracks and within a short time difference between last seen of old track and first seen of new track is particularly useful for analyzing traffic flow in complex urban environments, where multiple vehicles may pass through the same region at different times.

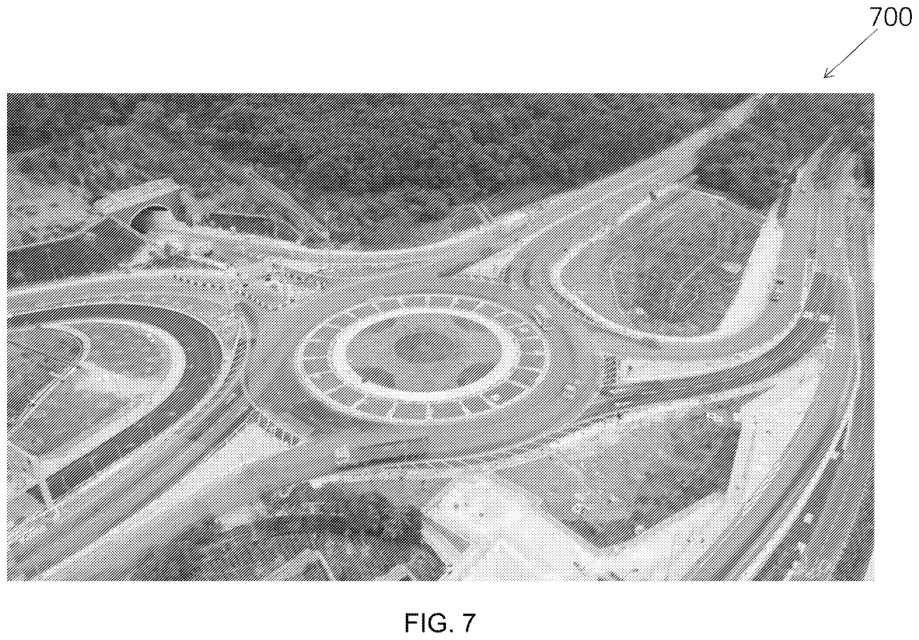

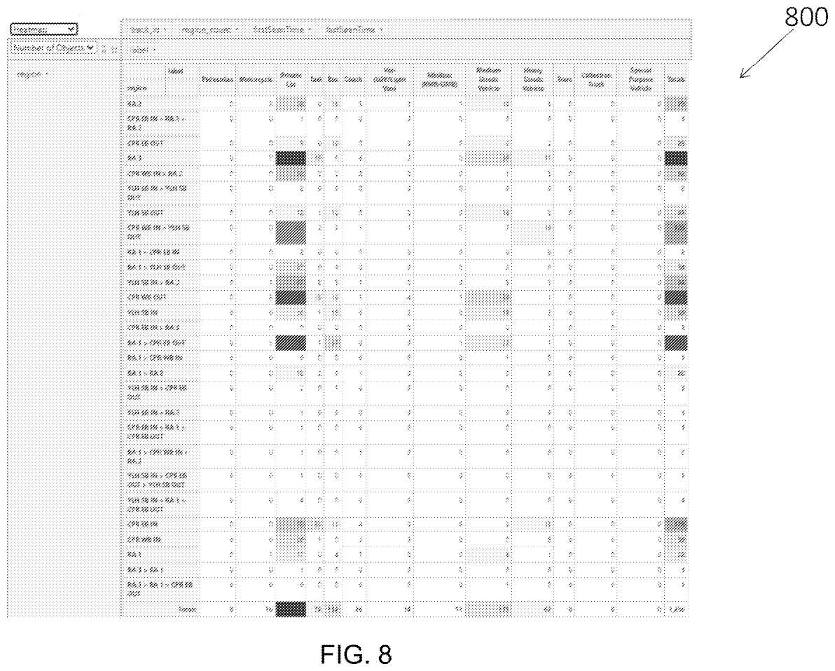

After identifying all detectable objects of interest in the image sequence, the collected tracking data may be converted into different forms of representations. For example, with reference to FIG. 7, a traffic flow diagram 700 may be created, by overlaying the detected travelling path of detected vehicles (and/or pedestrians) on an image of the scene being captured. Alternatively, referring to FIG. 8, a heatmap 800 showing counts of different categories of objects may be displayed, representing utilization of different road/junctions by different types of vehicles or pedestrians.

In addition, other types or formats of traffic data reports may be generated. For example, the reports may include the tracking and counting result of defined counting regions within a defined date time range, estimated traffic speed and level of service, travel speed and LOS table with the counting region specified, tracking summary table with the periods specified, counting summary table with the grouping specified, and raw data showing the time, track ID, class, and region sequence that vehicles and pedestrians pass through, as well as estimated travel speed.

These reports may be particularly useful for analyzing traffic flow and congestion, identifying areas where improvements in traffic flow and management are needed, and for implementing strategies to improve traffic flow and reduce congestion in complex urban environments.

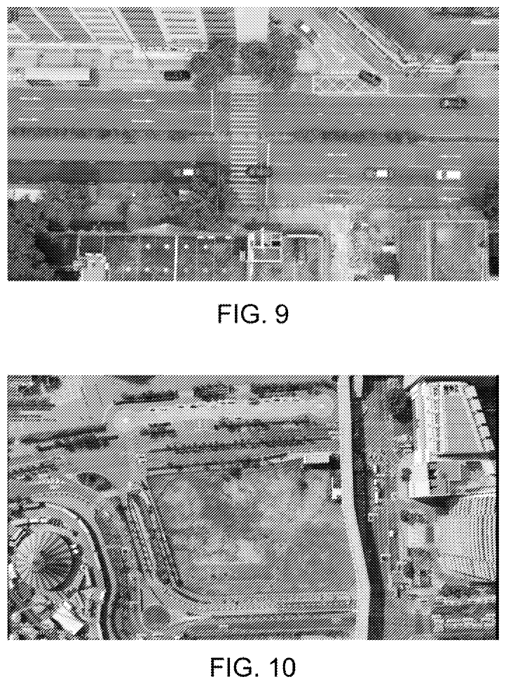

Preferably, the sequence of images are captured at a shooting angle of a top view or a tilt view. Referring to FIGS. 9 and 10, the system supports two shooting angles for drone videos: top view (e.g. FIG. 10) and tilt view (FIG. 9). The top view captures video on the top of the road to perform a higher accuracy of traffic counts, while the tilt view captures video from the side of the road to perform a higher accuracy of vehicle type classification and pedestrian count. This feature may be particularly useful for analyzing traffic flow in different types of roads and intersections, and for identifying the different types of vehicles and pedestrians that pass through these areas.

In one preferred embodiment, the system may be used to detect objects in an input 4K video captured by drones with shooting height ranging from 50 m to 90 m, which may be the suitable for analyzing traffic flow and congestion in large urban areas, where regular ground-based monitoring may be difficult or time-consuming. Alternatively, high resolution cameras mounted on external walls of high-rise building or at a predetermined height using a pole mounted on the ground surface may be used for capturing the input video for traffic analytic purpose.

The UAS with AI technology can operate at heights between 50 and 90 meters and can capture videos from different camera angles, including top view and 45-degree angles. The system includes an image stabilizer to prevent vibrations during image capture. This enables the UAS to capture detailed and accurate footage, even in challenging weather conditions.

Preferably, the system's ability to stabilize the videos using traffic counts, by defining a stabilization region and modifying the position of the detection zone during processing, further enhances the accuracy of the data collected. To extract traffic data with the time captured, users can provide metadata or input datetime created by the camera or drone system to provide corresponding in/out time of the objects.

Optionally or additionally, the system may further comprise a correction module 110 arranged to correct a trajectory of the at least one object with reference to a template image representing a stabilizing region in the sequence of images. More preferably, the correction module 110 is arranged to slide the template image defined by a user selected from one of the images in the sequence of image to match with an identical region in each of the images in the sequence; and to correcting the coordinate of the detected object by offsetting the movement of the unmanned aircraft system based on a shift of the template image at different frames of the sequence of image.

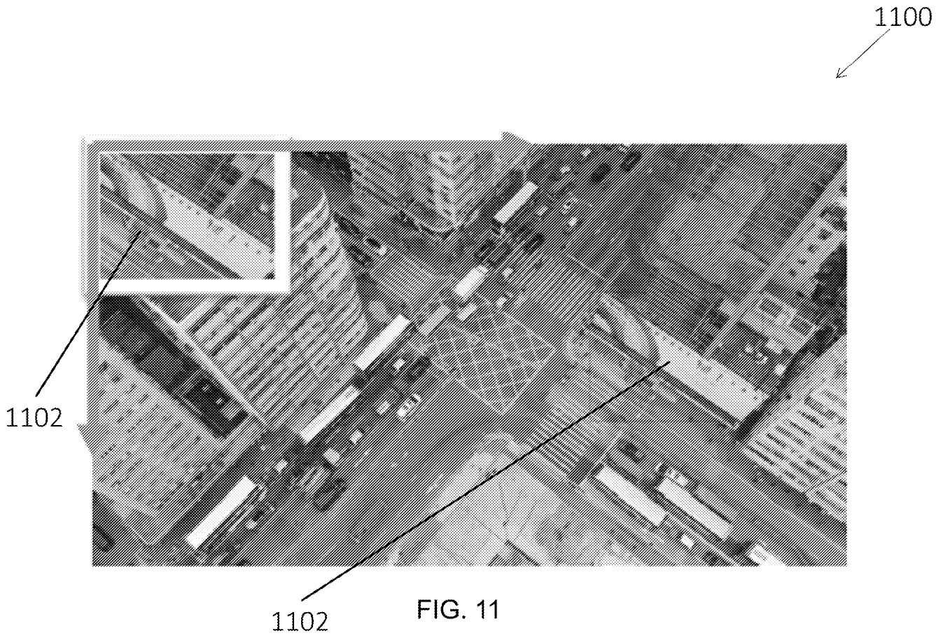

With reference to FIG. 11, to tackle the instability of UAS, the system may employ a template matching method, where the source image 1100 is each video frame and the template image 1102 is a user-defined stabilizing region, for example, a cropped region 1102 which appears to be regularly captured in the entire input video clip. The system identifies the matching area by sliding it and calculates the coordinates moved to apply to each track of the object. This feature may particularly useful for stabilizing the video feed and reducing the influence of movement caused by the instability of the UAS.

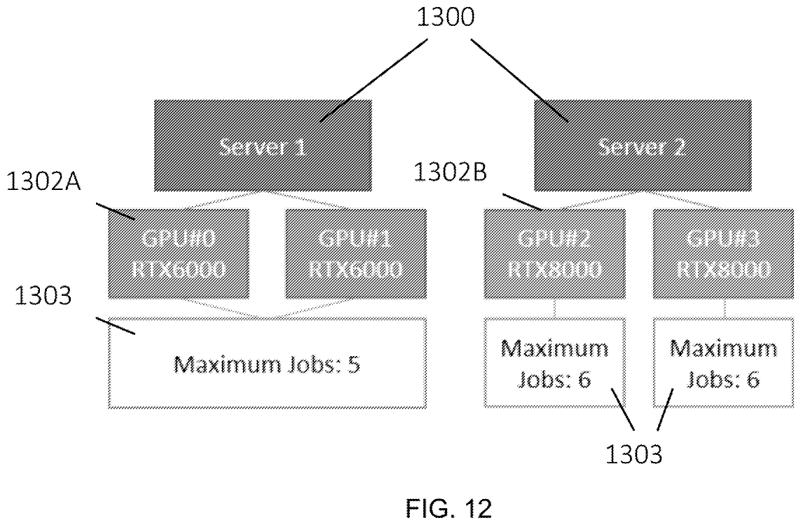

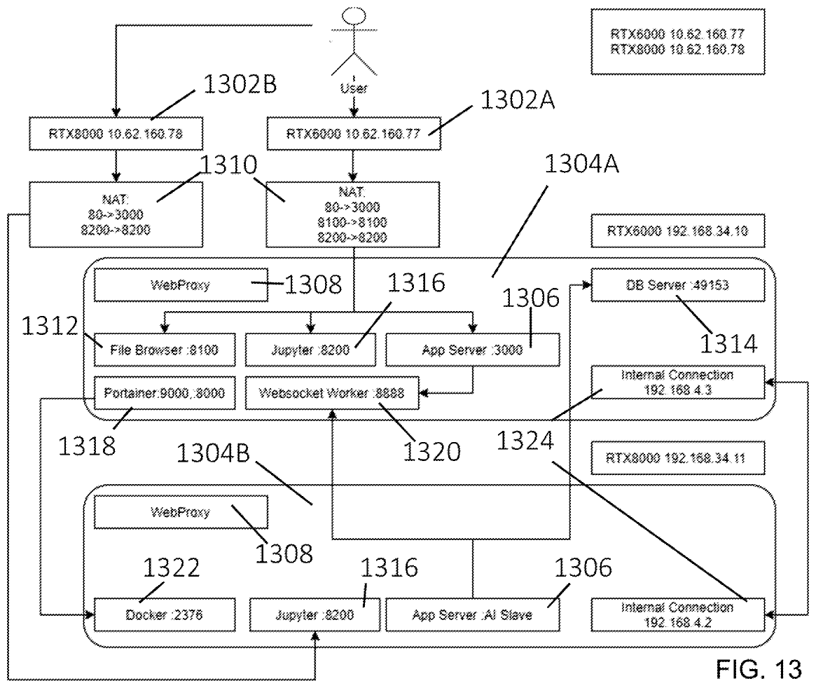

With reference to FIGS. 12 and 13, the system 100 is may support multiple physical servers 1300 and dynamically assign jobs based on RAM and CPU time. The system may assign detection job 1303 by considering the RAM and GPU memory of both servers without affecting the system's normal operation. The system may evenly distribute jobs to both servers and prevent out of memory issues by not starting a new job until the RAM has been checked to have 25% free memory.

In this example, a user may submit a request to “server 1” 1302A installed with a RTX6000 GPU, via a gateway with a network address “10.62.160.77” and at the same time another request to “server 2” 1302B installed with an RTX8000 GPU, via a gateway with a network address “10.62.160.78. Based on the resources on different server, the request may be distributed to different processor systems 1304A and 1304B, via a NAT 1310. In addition, each of the processor system are provided with different functional modules, such as “App server” 1306, “web proxy” 1308, a file browser 1312, a DB server 1314, a Jupyter 1316, a portainer 1318, a websocket worker 1320 and/or a docker 1322 for providing different functions if necessary. Additionally, or optionally, processing systems 1304 may be connected via an internal connection 1324.

The inventors performed tests and evaluations of the system implemented in accordance with an embodiment. For this exemplary system, it has an accuracy of about 95% for both stop line counts and trajectory counts for vehicle detection. The system also supports pedestrian detection with accuracy of about 102% (overcounting). Advantageously, the system may support traffic flow and congestion in different types of roads and intersections being accuracy analyzed, especially for identifying areas where improvements in traffic flow and management are needed.

These embodiments may be advantageous in that the object tracking system provides a more efficient way to survey traffic flow and provides comprehensive analysis data, which can help with traffic planning and business needs. UAS for traffic survey can cover a much larger area with fewer manpower resources, making it cost-effective. The system can track vehicle speed and provide fast responses to business needs. It can also analyze roundabout traffic flow, which is an essential feature for traffic planning.

Advantageously, the system for traffic survey using unmanned aircraft system is a highly advanced and effective tool for analyzing traffic flow and congestion in complex urban environments. Its ability to detect objects from 4K video, stabilize videos using traffic counts, and support tiny object detection and multiple object tracking, as well as providing traffic data reports, make it an essential tool for traffic management and planning in large urban areas.

Moreover, the system has been tested which is efficient and accurate in detecting and classifying different types of vehicles and pedestrians, with an accuracy of about 95% for stop line counts and trajectory counts for vehicle detection and about 102% for pedestrian detection. It ensures that the system can provide highly reliable and accurate data that can be used to develop effective traffic management and planning strategies.

In addition, the system may support drone videos captured with top view and tilt view angles, which are highly effective in capturing traffic data from different perspectives. The top view captures video on the top of the road, providing a higher accuracy of traffic counts, while the tilt view captures video from the side of the road, providing a higher accuracy of vehicle type classification and pedestrian count. This feature ensures that the system can capture traffic data from different angles and perspectives, providing a more comprehensive and accurate view of traffic flow and congestion in complex urban environments.

The inventors devised that the system may be used by Transport Department (TD). The TD can flexibly deploy the UAS to remote areas for monitoring road conditions, especially during inclement weather and public events when land access can be a problem. The UAS can provide ad hoc surveys and extract traffic data, including vehicle flow, vehicle classification, pedestrian flow, and traffic queue length. This information is useful for traffic planning. The system may provide an indispensable tool for traffic management authorities and transportation companies worldwide, and an essential tool for traffic management and planning in large urban areas.

In addition, the incorporation of UAS with AI technology into the survey business has brought many advantages. The system provides comprehensive analysis data, which can help survey businesses make informed decisions. It can track vehicle speed, which is essential for analyzing roundabout traffic flow. The system can also provide fast responses to business needs. The system's efficiency, accuracy, and dynamic capabilities ensure that it can operate effectively and efficiently, providing highly reliable and accurate data that can be used to develop effective traffic management and planning strategies.

Although not required, the embodiments described with reference to the figures can be implemented as an application programming interface (API) or as a series of libraries for use by a developer or can be included within another software application, such as a terminal or personal computer operating system or a portable computing device operating system. Generally, as program modules include routines, programs, objects, components and data files assisting in the performance of particular functions, the skilled person will understand that the functionality of the software application may be distributed across a number of routines, objects or components to achieve the same functionality desired herein.

It will also be appreciated that where the methods and systems of the present invention are either wholly implemented by computing system or partly implemented by computing systems then any appropriate computing system architecture may be utilized. This will include tablet computers, wearable devices, smart phones, Internet of Things (IoT) devices, edge computing devices, stand alone computers, network computers, cloud-based computing devices and dedicated hardware devices. Where the terms “computing system” and “computing device” are used, these terms are intended to cover any appropriate arrangement of computer hardware capable of implementing the function described.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

Any reference to prior art contained herein is not to be taken as an admission that the information is common general knowledge, unless otherwise indicated.

The invention claimed is:

1. An object tracking system for use in traffic flow analytics, comprising:
an image processing module arranged to receiving a sequence of images capturing at least one object moving along a predetermined path in an area;
an object detection module arranged to detect the at least one object including identifying a predetermined category of the detected object; and
an object tracking module arranged to track the at least one object travelling from an entrance to an exit of the predetermined path based on coordinates of the object in the sequence of images being detected.

2. The object tracking system in accordance with claim 1, wherein the sequence of images are captured by an unmanned aircraft system.

3. The object tracking system in accordance with claim 2, wherein the sequence of images are captured at a shooting angle of a top view or a tilt view.

4. The object tracking system in accordance with claim 1, wherein the object detection module comprises a modified tiny object detection network arranged to process the sequence of images.

5. The object tracking system in accordance with claim 4, wherein the modified tiny object detection network is arranged to process a plurality of at least partially overlapping image tiles having an image resolution smaller than an original resolution of the sequence of images.

6. The object tracking system in accordance with claim 1, wherein the object tracking module is arranged to assign a track ID for each of the at least one object being detected; and to track the movement of the at least one object using a Simple Online and Realtime Tracking with a Deep Association Metric process.

7. The object tracking system in accordance with claim 6, wherein the object tracking module is further arranged to assign a new track ID to a lost object which is not detectable in one or more previous frames; and to perform a merge track process to determine whether an identical object assigned with different track IDs travelled from the entrance to the exit of the predetermined path.

8. The object tracking system in accordance with claim 2, further comprising a correction module arranged to correct a trajectory of the at least one object with reference to a template image representing a stabilizing region in the sequence of images.

9. The object tracking system in accordance with claim 8, wherein the correction module is arranged to slide the template image defined by a user selected from one of the images in the sequence of image to match with an identical region in each of the images in the sequence; and to correcting the coordinate of the detected object by offsetting the movement of the unmanned aircraft system based on a shift of the template image at different frames of the sequence of image.

10. The object tracking system in accordance with claim 1, wherein the predetermined category of the detected object includes at least one of pedestrians, a taxi, a coach, a bus, a tram, a collection truck and a special purpose vehicle.

11. A traffic flow analytic method, comprising the steps of:
receiving a sequence of images capturing at least one object moving along a predetermined path in an area;
detecting the at least one object including identifying a predetermined category of the detected object; and
tracking the at least one object travelling from an entrance to an exit of the predetermined path by detecting coordinates of the object in the sequence of images.

12. The traffic flow analytic method in accordance with claim 11, wherein the sequence of images are captured by an unmanned aircraft system.

13. The traffic flow analytic method in accordance with claim 12, wherein the sequence of images are captured at a shooting angle of a top view or a tilt view.

14. The traffic flow analytic method in accordance with claim 11, wherein the step of detecting the at least one object comprising the step of processing the sequence of images by using a modified tiny object detection network.

15. The traffic flow analytic method in accordance with claim 14, wherein the modified tiny object detection network is arranged to process a plurality of at least partially overlapping image tiles having an image resolution smaller than an original resolution of the sequence of images.

16. The traffic flow analytic method in accordance with claim 11, wherein the step of tracking the at least one object travelling from the entrance to the exit of the predetermined path comprises the step of:
assigning a track ID for each of the at least one object being detected; and
using a Simple Online and Realtime Tracking with a Deep Association Metric process to track the movement of the at least one object.

17. The traffic flow analytic method in accordance with claim 16, wherein the step of tracking the at least one object travelling from the entrance to the exit of the predetermined path further comprises the steps of:
assigning a new track ID to a lost object which is not detectable in one or more previous frames; and
performing a merge track process to determine whether an identical object assigned with different track IDs travelled from the entrance to the exit of the predetermined path.

18. The traffic flow analytic method in accordance with claim 12, further comprising the step of correcting a trajectory of the at least one object with reference to a template image representing a stabilizing region in the sequence of images.

19. The traffic flow analytic method in accordance with claim 18, wherein the step of correcting the trajectory of the at least one object comprising the steps of:
sliding the template image defined by a user selected from one of the images in the sequence of image to match with an identical region in each of the images in the sequence; and
correcting coordinates of the detected object by offsetting the movement of the unmanned aircraft system based on a shift of the template image at different frames of the sequence of image.

20. The traffic flow analytic method in accordance with claim 11, wherein the predetermined category of the detected object includes at least one of pedestrians, a taxi, a coach, a bus, a tram, a collection truck and a special purpose vehicle.
